(19) United States
(12) Patent Application Publication
(10) Pub. No.: US 2005/0209036 A1
(43) Pub. Date: Sep. 22, 2005

(54) Bi-powered clutchless variable speed transmission

(76) Inventor: William R. Cole, Plainfield, IN (US)

Correspondence Address: WILLIAM R. COLE, 8760 S. CR 825 E, PLAINFIELD, IN, 46168, US

(21) Appl. No.: 11/129,010

(22) Filed: May 13, 2005

Related U.S. Application Data
(63) Continuation-in-part of application No. 10/461,570, filed on Jun. 14, 2003.

(51) Int. Cl. F16H 3/72

(52) U.S. Cl. 475/7

(57) ABSTRACT

When the primary power supply motor 1 is powered up and running the primary shaft is connected to the Planetary Gear assembly 5, while motor 24 is not running. The output shaft out of Planetary Gear assembly 11A is zero. As power goes through Planetary Gear assembly 5 and transfers the power through the bevel gear and then the worm gear on Planetary gear assembly 11A, which then rotates the ring gear at the appropriate speed to cause the Planetary Gears to remain stationary about the sun gear. Consequently no power is transferred to the output shaft. When motor 24 is powered up, and as its speed increases it starts the rotation of the ring gear on Planetary Gear assembly 11 and causes the output shaft to reduce its speed and in turn this change in speed is transferred to the ring gear on Planetary Gear assembly 11A which now starts the rotation of the output shaft of assembly 19.

### BACKGROUND OF INVENTION

The objective is to develop a transmission which uses an air cooled internal combustion engine. Using this kind of a transmission will accommodate the use of air cooled engines apposed to water cooled engines.

### DESCRIPTION

This present invention relates to a clutchless transmission, and more particularly to a bi-powered clutchless variable speed transmission for use in multiple power supply facilities.

### SUMMARY OF THE INVENTION

The present invention in brief is a clutchless variable speed transmission which consists of a primary shaft and a control shaft which in both of the shafts lies planetary speed reduction gears to enhance the rpm, and possibly could enhance mileage per gallons. Another embodiment includes primary power supply and a control motor which could possibly eliminate starters on large electric motors. In addition the objective of the present invention is its ability to utilize different types of primary operating power.

### BRIEF DESCRIPTION OF THE DRAWINGS

FIG. 1. is a 3D drawing of the Bi-Powered Clutchless Variable Speed Transmission, showing primary and secondary power shaft and a primary power supply

FIG. 2. is a cutaway 3D drawing of the Primary Power Shaft

FIG. 2-1 is a cutaway schematic of the Primary Power Shaft

FIG. 3. is a cutaway 3D drawing of the Secondary Control Shaft

FIG. 3-1 is a cutaway schematic of the Secondary Control Shaft

### PREFERRED EMBODIMENTS

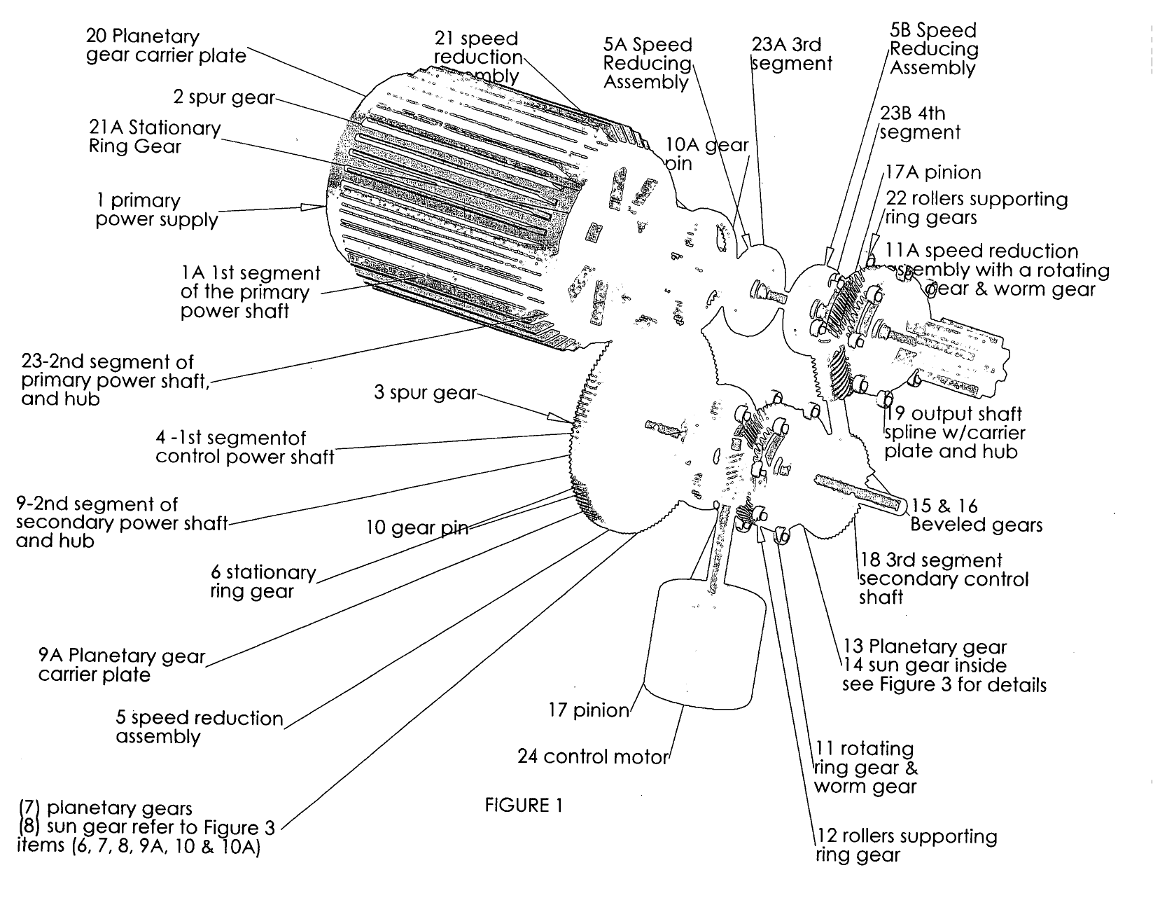

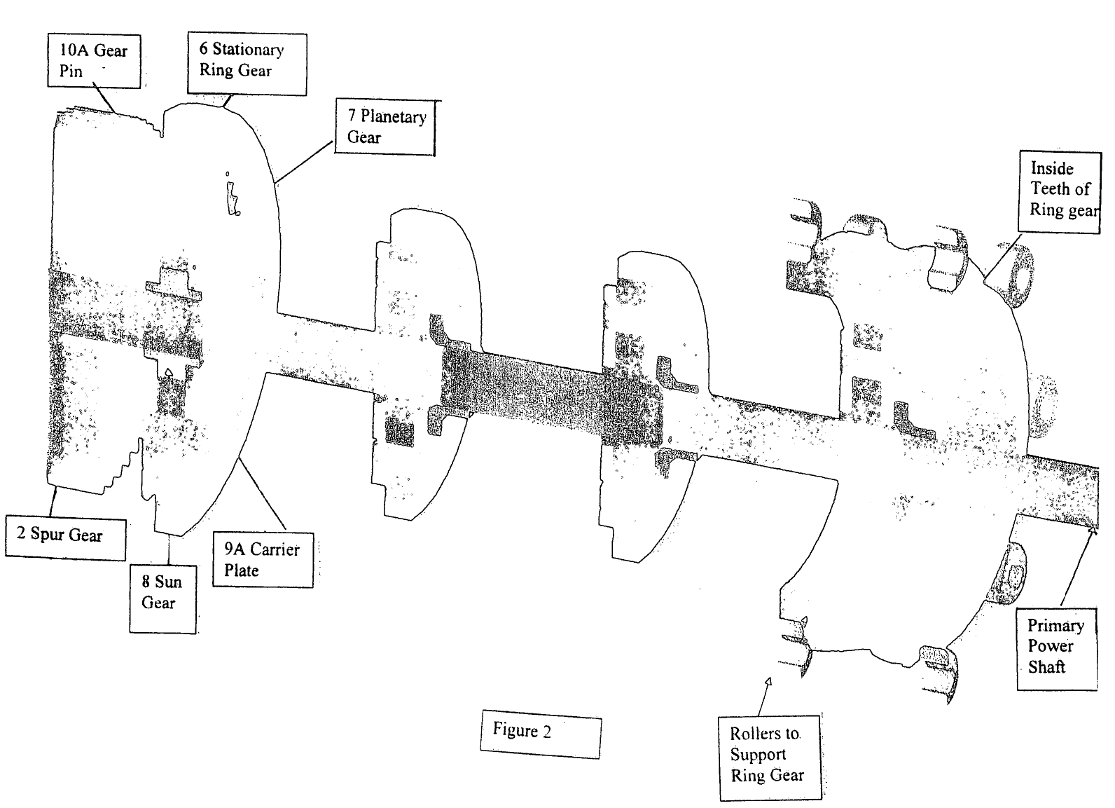

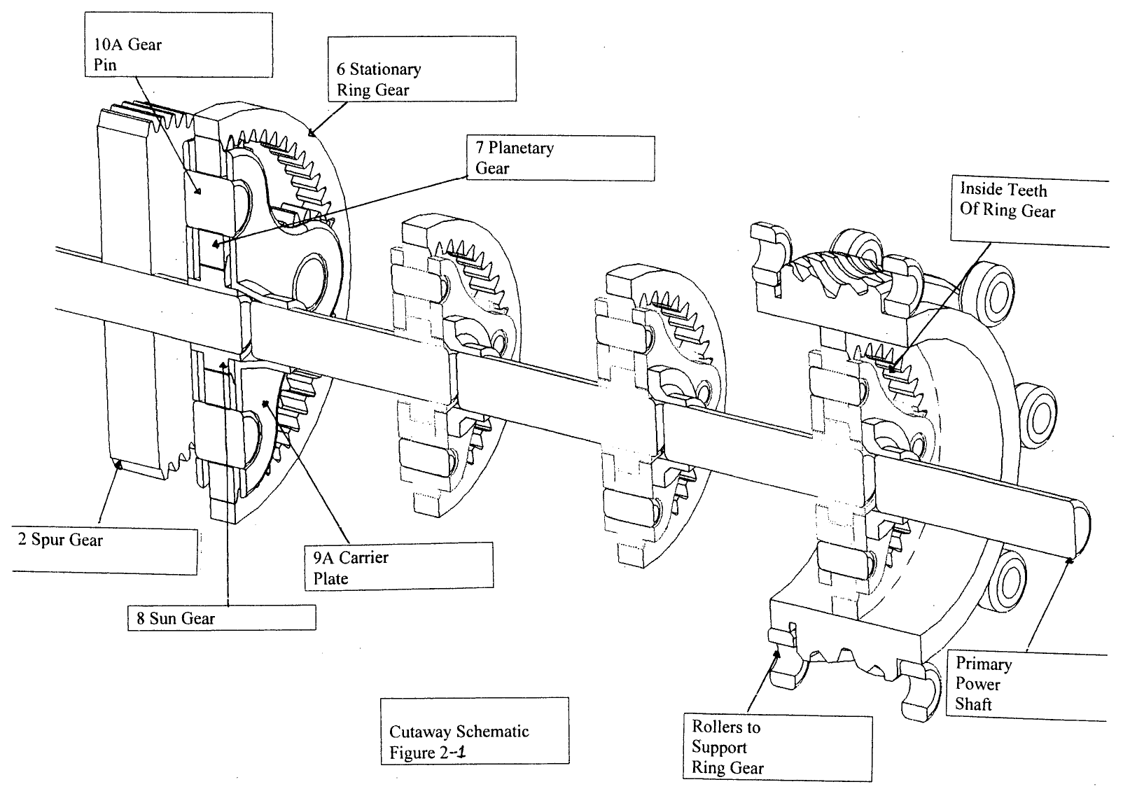

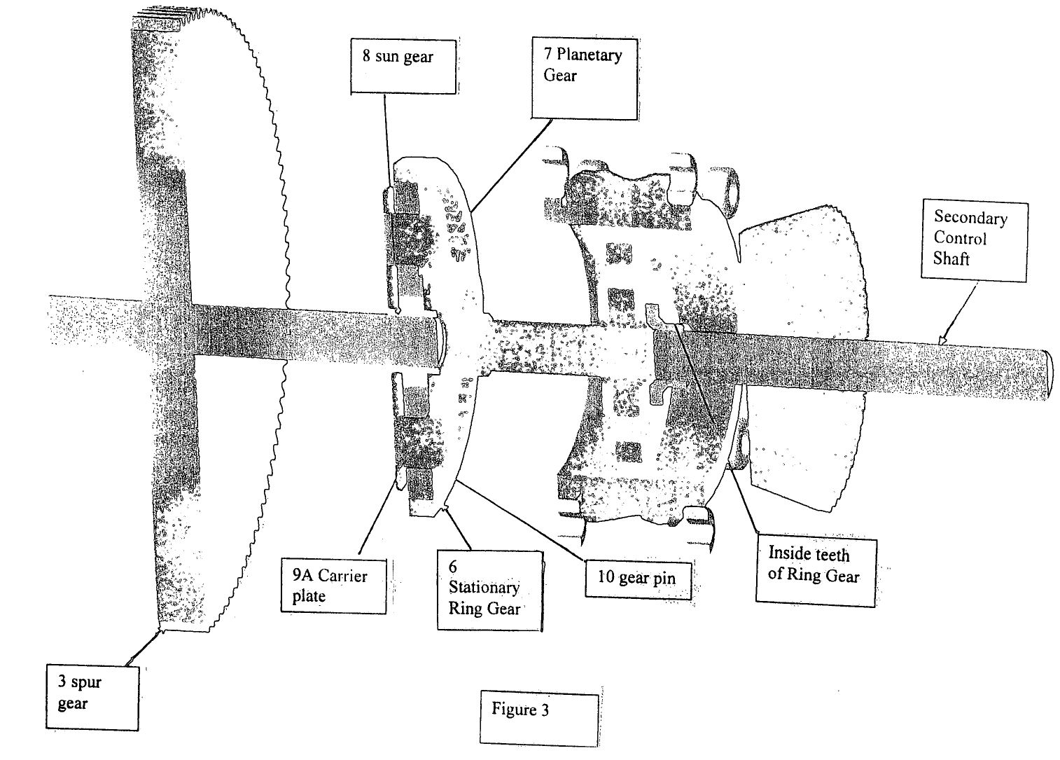

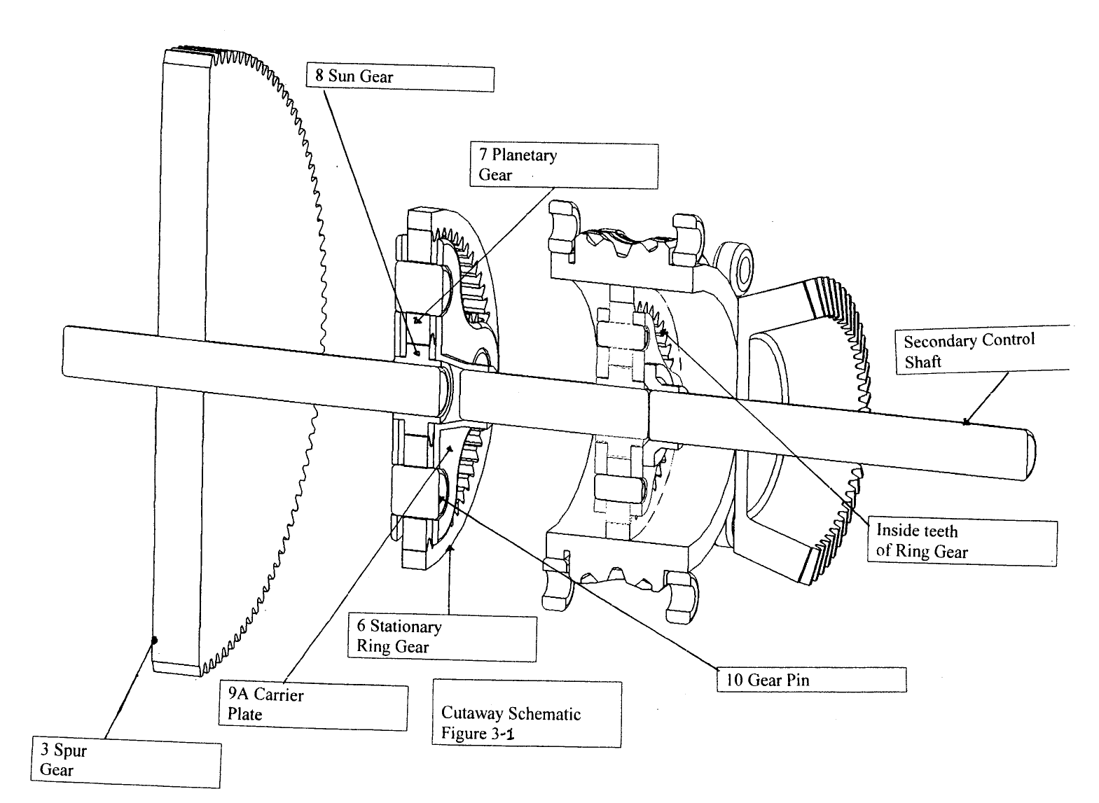

As shown in the diagram of FIG. 1 a bi-powered clutchless variable speed transmission consists of a Primary power supply 1, which gives the transmission its power. As the Spur gear 2 receives the power it rotates and drives Spur Gear 3 in the control assembly. The shaft which the Spur gear 3 is attached to is the controlled power shaft 4, which in turn operates the entire planetary gear speed reduction assembly 5, which includes the ring gear 6, planetary gears 7 and sun gear 8, which also can be viewed on FIG. 3 of the cutaway of items 9A carrier plate and 10 gear pin. The carrier plate 9A drives the second segment of the control shaft which lies between the stationary ring gear 6 and the rotating ring gear and worm gear 11. The carrier plate and the rotating ring and worm gear 11 drives the third segment of the control shaft which supports and drives the beveled gear 15 which in turn drives beveled gear 16 which drives the shaft and pinion gear 17 and the shaft. The rollers 12 are supporting the rotating ring gear and worm gear 11. Making the transition to the primary power shaft FIG. 2, which starts at the spur gear 2, is mounted on the first segment of the 1A primary power shaft and turns the assembly with a stationary ring gear 21 which rotates the hub, which rotates the second segment of the primary power shaft 23, which in turn turns the planetary gear speed reduction 5A, which in turn rotates the third segment 23A which in turn operates the Speed reducing assembly 5B which in turn rotates the fourth segment of the primary power shaft 23B which rotates the speed reduction assembly with the rotating ring gear and worm gear 11A which moves to the fifth segment of the power shaft 19.

As shown in the diagram of FIG. 1 the control motor 24 rotates the pinion 17 which rotates the ring gear and worm gear 11.

When the primary power supply is energized it rotates both the primary and secondary power shafts. The rotation of the primary shaft travels to the speed reduction assembly 5B and at the same time the rotation of the secondary power shaft is transferred at the same speed reduction assembly 5B and the pinion rotates the ring gear in the same direction and RPM as the planetary gear carrier plate, thus counteracting the rotation of the output shaft with the result of the output shaft rotation is zero. When the control motor is energized the pinion rotates the rotating ring gear 13. The speed of the bevel gears is now reduced and reducing the speed of the pinion and ring gear 11A. Increasing the speed at the control motor to the point where the pinion and rotating ring gear 11A stops then the rotation of the primary output shaft 9 will then increase to its maximum speed under these conditions.

The source and method supplying power for both primary and secondary control shafts is unlimited.

1. A bi-powered clutchless variable speed transmission drive assembly one of the primary benefits of this bi-powered clutchless variable speed transmission is the ability to control the speed of the output shaft which consists of two shafts, a primary power shaft and a secondary power shaft.

2. A bi-powered clutchless variable speed transmission drive assembly also has the ability of operating on an infinite variable speed according to claim 1 allows the transmission the ability to control the speed of the output shaft.

3. A bi-powered clutchless variable speed transmission drive assembly also has the ability to receive power from motor 1 regardless of its type of power system according to claim 2 has the ability of operating on an infinite variable speed.

4. A bi-powered clutchless variable speed transmission drive assembly motor 24 also has the ability to operate under any type of power system according to claim 3 has the ability to receive power from motor 1 regardless of its type of power system and motor 24 also has the ability to operate under any type of power system, and to accommodate a high speed motor the power supply must run at a high rate of speed, as the planetary gears assemblies are required, however, operating an extremely low power motor than the planetary gear assemblies are not needed.
